(19) United States
(12) Patent Application Publication
(10) Pub. No.: US 2025/0359529 A1
(43) Pub. Date: Nov. 27, 2025

(54) Litter Box for Pets

(71) Applicant: Kusa Weir, Werribee (AU)

(72) Inventor: Kusa Weir, Werribee (AU)

(21) Appl. No.: 18/779,136

(22) Filed: Jul. 22, 2024

(30) Foreign Application Priority Data
May 24, 2024 (AU) 2024203499

(51) Int. Cl. A01K 1/01

(52) U.S. Cl. CPC A01K 1/0114

(57) ABSTRACT

A litter box for pets comprises of a plurality of sections comprising an upper section and a lower section. The upper section has a containment wall to prevent litter ejection and waste leakage. The lower section is configured with a perforated tray for holding wood pellet litter. A litter scoop is included for managing waste dust. The lower section houses a removable tray positioned beneath the perforated tray to receive the liquid waste and sifted fine particles produced due to contact between the pellet and the liquid waste. Further, the lower section is configured with a funneled section to ensure easy disposal of the collected waste material.

### CROSS-REFERENCE TO RELATED APPLICATION

This disclosure claims the benefit of the priority of Australian Patent Application No. 2024203499 entitled “Sifting Litter Box” and filed on May 24, 2024. The above-identified applications are incorporated herein by reference in its entirety.

### FIELD OF THE INVENTION

The present invention relates to a pet care product and more particularly to a litter box for pets that aids in the management of waste produced by domestic pets through a multi-sectioned litter box in order to maintain hygiene.

### BACKGROUND OF THE INVENTION

The litter box for pets is mainly essential for pet owners, particularly those with domestic cats. The traditional litter boxes often consist of a simple container filled with litter material, such as clay or silica, which is cumbersome to clean and maintain. Over times, these conventional designs led to issues such as odour, litter scatter, and inefficient waste separation, making them less than ideal for pet owners seeking a sanitary and low-maintenance solution.

Wood pellet litter has gained popularity due to its natural odour control biodegradability, and ability to absorb moisture effectively. However, typical litter boxes do not fully leverage the benefits of wood pellet litter, often leading to clumping and inefficient waste separation. As the pellet absorb moisture, they break down into fine particles, which get mixed with the remaining pellets and create a messy environment.

U.S. Pat. No. 7,380,519B2 discloses pet litter box includes a litter container for storing liquid-passing litter and a liquid-absorbing sheet tray for bolding a liquid-absorbing sheet. The front-back direction of the liquid-absorbing sheet can be changed without removing the liquid-absorbing sheet from the tray. The pet litter box includes a litter box main body having an opening from which pets enter. The litter box main body includes a litter container for storing liquid-passing litter formed of plural of granular materials provided therein, a liquid-absorbing sheet placed below the litter container for absorbing the liquid passing through the litter, and a liquid-absorbing sheet tray for holding the liquid-absorbing sheet. The liquid absorbing sheet tray can be withdrawn and removed from the front of the litter box main body and reversible in the front-back direction. Although, the pet litter box aids in the management of liquid waste produced by the domestic pet through multi-sectioned chamber. However, the cited document utilizes a liquid-absorbing sheet for separation of liquid waste that needs to be constantly replaced, increasing the cost. Moreover, the cited document is incapable of preventing scattering of litter.

U.S. Pat. No. 8,166,919B2 relates to self-cleaning litter box provides various advantages over the prior art. In particular, in one embodiment, the self-cleaning litter box is configured to use a one-piece litter cartridge having a litter compartment and a waste compartment. In another embodiment, the cartridge is non-compartmentalized. In another embodiment, the system includes a rake assembly configured with a drive assembly that is protected from waste contamination. In accordance with the invention, the self-cleaning litter box is configured to be used with all types of litter including crystal type litter. Although, the self-cleaning litter box is capable of successfully maintaining hygiene by efficient management of litter. However, the cited document is incapable of preventing scattering of litter.

Conventionally, there exist several litter boxes and scooping pans that attempt to maintain hygiene by managing waste produced by the domestic pets. However, these litter boxes and scooping pans lacks in separation of liquid and solid waste, maximizing the effectiveness of wood pellet litter and minimizing litter scatter.

Therefore, there exists a need to develop a litter box that maximizes the effectiveness of wood pellet litter, facilitates easy separation of liquid and solid waste, and minimizes litter scatter.

### OBJECTS OF THE INVENTION

The principal object of the present invention is to provide a solution to the existing litter box for pets.

The object of this invention is to provide a litter box for pets that aids in the management of waste produced by domestic pets through a multi-sectioned litter box in order to maintain hygiene.

Another object of the present invention is to provide a litter box that maximizes effectiveness of the wood pellet litter along with minimizing scattering of the litter.

Another object of the present invention is to reduce the overall effort required by the user in maintaining the litter box.

Yet another object of the invention is to provide a litter box that facilitates easy separation of liquid and solid waste to prevent break down of wood pellet litter into fine particles, eliminating messy environment.

The foregoing and other objects, features, and advantages of the present invention will become readily apparent upon further review of the following detailed description of the preferred embodiment as illustrated in the accompanying drawings.

### SUMMARY OF THE INVENTION

The present invention relates to a litter box for pets that provides multi-sectioned structure for waste management in view of maintaining hygiene and cleanliness by separating liquid waste and solid waste.

According to an embodiment of the present invention, the litter box for pets comprises of a plurality of sections comprising an upper section, a sifting section, and a lower section. The upper section comprises containment walls to prevent litter ejection and liquid waste leakage. The containment walls are configured to have an ergonomic height to accommodate different sizes of pets while preventing litter spillage. The shifting section comprises a perforated tray for holding wood pellet litter and allowing the liquid waste excreted by a pet to pass through while retaining solid waste and litter. A litter scoop is provided for stirring and managing the waste dust created due to contact between liquid waste and the wood pellet litter. The lower section houses a removable tray positioned beneath the perforated tray to receive the liquid waste and sifted fine particles produced due to contact between the pellet and the liquid waste. In one embodiment of the present invention, the removable tray in the lower section is made up of a material resistant to corrosion and odor retention. Further, the lower section is configured with a funneled section for ease of disposal of the collected waste material.

Moreover, the lower section is crafted with an opening for allowing a user to access the removable tray for easy disposal of the waste.

In one embodiment of the present invention, the perforations of the perforated tray vary in size and shape. In another embodiment of the present invention, the perforations of the perforated tray are elongated in shape.

In one embodiment of the present invention, the litter box for pets further comprises of the litter scoop featuring a handle with an ergonomic grip for easy handling and stirring the litter.

According to another embodiment of the present invention, the removable tray is configured with a plurality of support members for secure holding of the tray within the lower section.

In one embodiment of the present invention, the plurality of sections of the litter box is detachable, i.e. the upper section, sifting section and lower section, all are detachable.

While the invention has been described and shown with particular reference to the preferred embodiment, this will be apparent that variations might be possible that would fall within the scope of the present invention.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below.

To further clarify advantages and features of the present invention, a more particular description of the invention will be rendered by reference to specific embodiment thereof, which is illustrated in the appended drawings. It is appreciated that these drawings depict only typical embodiments of the invention and are therefore not to be considered limiting of its scope. As will be appreciated, other embodiments of the present invention are possible utilizing, alone or in combination, one or more of the features set forth above or described in detail below.

### BRIEF DESCRIPTION OF THE DRAWINGS

These and other features, aspects, and advantages of the present invention will become better understood with regards to the following description, appended claims, and accompanying drawings where:

FIG. 1A illustrates a perspective view of the litter box in accordance with the embodiment of the invention;

FIG. 1B illustrates a perspective view of an upper section in accordance with the embodiment of the invention;

FIG. 1C illustrates a perspective view of a sifting section in accordance with the embodiment of the invention;

FIG. 1D illustrates a perspective view of a lower section in accordance with the embodiment of the invention; and

FIG. 2 illustrates a perspective view of a litter box for pets indicating a removable tray in accordance with the embodiment of the invention.

### DETAILED DESCRIPTION OF THE INVENTION

The following description includes the preferred best mode of one embodiment of the present invention. It will be clear from this description of the invention that the invention is not limited to these illustrated embodiments, but the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a”, “an”, and “the” designate both the singular and the plural, unless expressly stated to designate the singular only.

Unless otherwise defined, all technical and scientific terms used herein have the same meaning as commonly understood by one of ordinary skill in the art to which this invention belongs. The present invention disclosed herein is illustrative only and not intended to be limiting.

Embodiments of the present invention will be described below in detail with reference to the accompanying drawings.

The present invention provides a practical and efficient solution for pet waste management. By utilizing wood pellet litter, the litter box ensures that liquid waste is quickly absorbed and converted into fine particles, which get easily sifted through the perforations. Further, the litter scoop developed for stirring pellet enhances the breakdown of waste and ensures that the litter remains effective for a longer period.

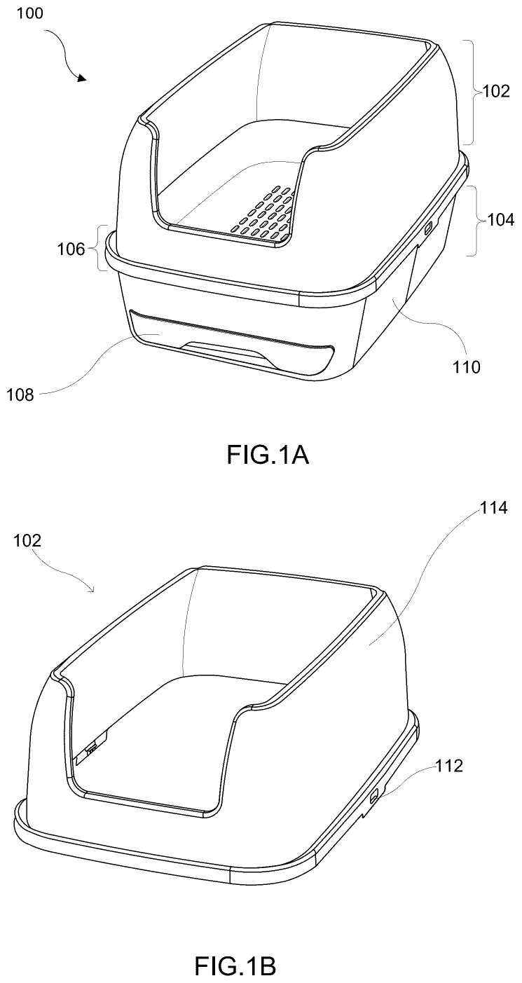

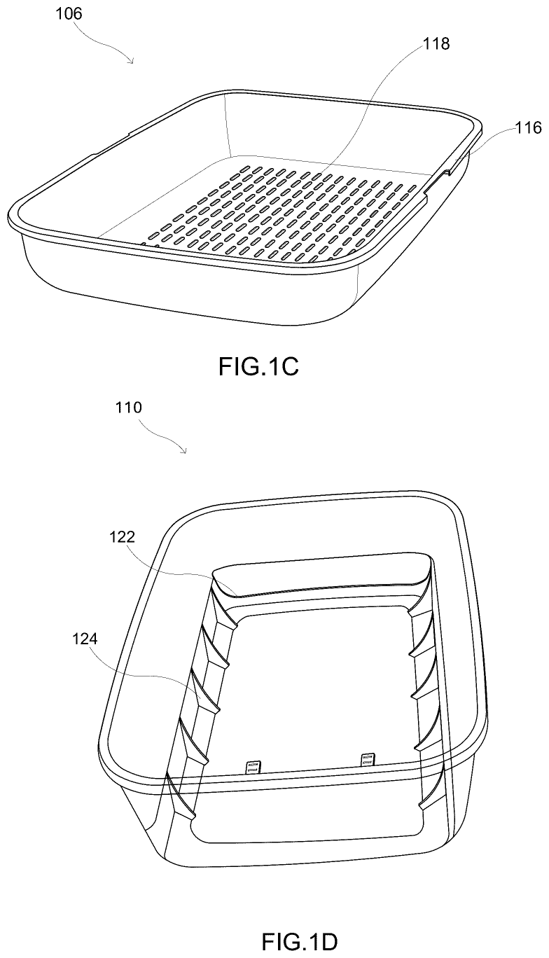

Referring to FIG. 1A, a perspective view of a litter box 100 comprises an upper section 102, a lower section 104 and a removable tray 108. In the embodiment, a sifting section 106 is provided between the upper section 102 and the lower section 104. The sifting section 106 comprises a perforated tray 118.

Referring to FIG. 1B, a perspective view of the upper section 102 associated with the litter box is illustrated comprising containment walls 114 and a snap-fit locking mechanism 112. The containment walls 114 to prevent litter ejection and liquid waste leakage. Herein, the containment walls 114 are configured to have an ergonomic height to prevent litter from being ejected during use by the pet and the walls also prevent liquid waste leakage, ensuring cleanliness around the litter box. The upper section 102 provides ample space for pets to urinate and defecate.

In one embodiment of the present invention, the upper section 102 comprises containment walls 114 having a plurality of side walls. In the embodiment, at least two sides of the plurality of side walls have equal height and equal length. In the embodiment, at least one side of the plurality of side walls provides passage for the entry to the litter box by a pet. In the embodiment, the containment walls 114 associated with the upper section 102 is rectangular periphery.

In one embodiment of the present invention, the containment walls 114 are configured with edges having a snap-fit locking mechanism 112 that is to be engaged with edges of the lower section 104 of the litter box.

Referring to FIG. 1C, a sifting section 106 is disclosed comprising the perforated tray 118. The perforated tray 118 is for holding wood pellet litter and allowing the liquid waste excreted by a pet to pass through while retaining solid waste and litter. The perforated tray 118 is crafted with several perforations and configured with a rim 116 that settles on the lower section 104. The perforations in the perforated tray 118 enable easy separation of the waste. A litter scoop (not shown in figures) is provided for stirring and managing the waste dust created due to contact between liquid waste and the wood pellet litter.

In one embodiment of the present invention, the perforations of the perforated tray 118 vary in size and shape. In another embodiment of the present invention, the perforations of the perforated tray 118 are elongated in shape.

The litter scoop is developed in manner to facilitate stirring of the litter. The stirring of the wood pellet litter helps to mix the wood pellets, allowing them to absorb moisture more efficiently and to break down into finer particles which can then sift through the perforated tray 118.

Referring to FIG. 1D, a perspective view of a housing 110 of the lower section 104 of the litter box without tray is disclosed. The housing 110 comprises a plurality of support members 124 extending vertically from bottom to side wall. The housing 110 of the lower section 104 houses tray and supported by the plurality of support members 124. In the embodiment, the housing 110 is provided with a window to insert and pull out the tray from the housing 110 for litter disposal. In the embodiment, the removable tray 108 is positioned beneath the perforated tray 118 to receive the liquid waste and sifted fine particles produced due to contact between the pellet and the liquid waste. In one embodiment of the present invention, the removable tray 108 in the lower section 104 is made up of a material resistant to corrosion and odor retention. In one embodiment of the present invention, the removable tray 108 is configured with a pull member 120 that enables the user to grip and move the removable tray 108 while inserting and pulling the removable tray 108. Further, the lower section 104 is configured with a funneled section 126 for ease of disposal of the collected waste material.

Moreover, the lower section 104 is crafted with an opening 122 for allowing the user to access the removable tray 108 for easy disposal of the waste.

According to another embodiment of the present invention, the lower section 104 includes the plurality of support members 124 that holds the removable tray 108 securely in place, preventing spillage and ensuring stability when the pet uses the litter box.

In one embodiment of the present invention, the litter box for pets further comprises of the litter scoop featuring a pull member with an ergonomic grip for easy handling and stirring the litter.

In one of the embodiments of the present invention, the upper section 102 and the lower section 104 are configured with the snap fit locking mechanism 112 to provide secure attachment.

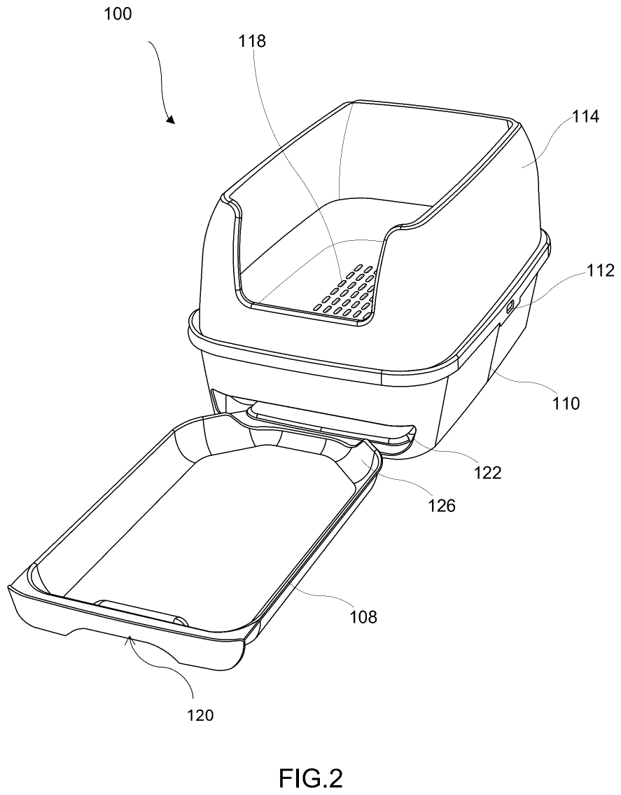

Referring to FIG. 2, a perspective view of a litter box 100 for pets is disclosed. In the embodiment, the litter box comprises a containment wall 114 in an upper section, a housing 110 in the lower section and a sifting section comprising perforated tray 118. The litter box further comprises a snap-fit locking mechanism 112, an opening 122 for allowing the user to access the removable tray 108 for easy disposal of the waste. In the embodiment, a pull member 120 that enables the user to grip and move the removable tray 108 while inserting and pulling the removable tray 108. Further, the lower section 104 is configured with a funneled section 126 for ease of disposal of the collected waste material.

In one embodiment of the present invention, the plurality of sections associated with the litter box is detachable, which means the upper section 102 is detachable from the lower section 104. Further, the perforated tray 118 is also detachable from the lower section 104.

In one embodiment of the present invention, the material used for construction of each section is durable, easy to clean, and resistant to odors, providing a long-lasting and sanitary solution for pet owners.

New characteristics and advantages of the invention covered by this document have been set forth in the foregoing description. It is to be expressly understood, however, that the expressions used in foregoing are for the purpose of illustration only and are not intended as a definition of the limits of the invention. Changes in the specification are capable of being made in detail without exceeding the scope of the invention by those who are skilled in the art. The scope of the invention is described in the appended claims hereinafter.

What is claimed is:

1. A litter box for pets, the litter box comprises of:
a plurality of sections comprising:
an upper section,
a sifting section, and
a lower section;
wherein the upper section is having containment walls to prevent litter ejection and liquid waste leakage;
the sifting section is configured with a perforated tray for holding wood pellet litter and allowing the liquid waste excreted by a pet to pass through while retaining solid waste;
the lower section houses a removable tray positioned beneath the perforated tray to receive the liquid waste and shifted fine particles produced due to contact between the pellet litter and the liquid waste;
characterized in that the lower section is configured with a funneled section for ease of disposal of the collected waste material.

2. The litter box as claimed in claim 1, wherein the containment walls are configured to have an ergonomic height to accommodate different size of pets while preventing litter spillage.

3. The litter box as claimed in claim 1, wherein the removable tray in the lower section is made up of a material resistant to corrosion and odor retention.

4. The litter box as claimed in claim 1, wherein the litter box comprises a litter scoop having a handle for stirring the litter.

5. The litter box as claimed in claim 1, wherein a plurality of support members is configured in the lower section for secure holding of the removable tray.

6. The litter box as claimed in claim 1, wherein an opening is crafted within the lower section for allowing a user to access the removable tray for easy disposal of the waste.

7. The litter box as claimed in claim 1, wherein the plurality of sections is detachable from each other.

8. The litter box as claimed in claim 1, wherein the upper section and lower section are configured with a snap fit locking mechanism to provide secure attachment.

9. The litter box as claimed in claim 1, wherein the litter box comprises a litter scoop having a handle for stirring the litter.
